(19) United States
(12) Patent Application Publication
(10) Pub. No.: US 2014/0057059 A1
(43) Pub. Date: Feb. 27, 2014

(54) STUCCO APPLICATOR

(71) Applicant: Vernon Victor Daubert, Beiseker (CA)

(72) Inventor: Vernon Victor Daubert, Beiseker (CA)

(21) Appl. No.: 13/592,193

(22) Filed: Aug. 22, 2012

(51) Int. Cl. B05C 5/02; B05D 7/00

(52) U.S. Cl. 427/600; 401/137

(57) ABSTRACT

A method and apparatus for applying a wall covering material to a wall surface. The apparatus comprises a body containing a reservoir for holding a portion of stucco material and a dispensing port extending therethrough, a handle extending from the reservoir and a vibrator for vibrating the reservoir. The method comprising introducing a quantity of material into a reservoir, locating the reservoir proximate to the wall surface, providing a vibration to the reservoir and moving the reservoir in the direction along the wall surface to apply a portion of the material to the wall.

### BACKGROUND OF THE INVENTION

1. Field of Invention

The present invention relates to wall coverings in general and in particular to a method and apparatus for applying stucco to a wall surface.

2. Description of Related Art

In the field of construction, many types of wall coverings are conventionally used to cover and protect the underlying wall structure. In particular, one type of wall covering that is conventional used is stucco. There are many advantages to using conventional stucco such as durability and appearance. However, conventionally it has been time consuming to apply to a wall surface. One conventional method for applying stucco to a wall surface is for a worker to hold or otherwise transport a portion of the stucco material to the wall surface whereupon the worker applies the stucco material to the wall surface with a hand trowel or the like.

Disadvantageously, the requirement to distribute or spread the stucco to the surface of the wall adds a time to the process of applying the stucco. Additionally, it will be appreciated that the quantity of stucco material that can be applied to the wall when utilizing such a method will be limited to the quantity that may be readily carried by the worker.

Other techniques of applying to go to a wall surface have also been unsatisfactory. In some other methods, have been to first apply the stucco to the wall surface using a sprayer, and thereafter distribute or evenly the move the stucco material around the wall surface using a trowel or the like. Spraying the stucco material to the wall surface without thereafter distributing it around with a hand trowel may result in a stucco layer that is uneven or inconsistent in depth. Furthermore, the requirement to distribute the stucco material about the wall surface using a hand trowel also add a second finishing step which adds additional time to the time required to complete the task.

### SUMMARY OF THE INVENTION

According to a first embodiment of the present invention there is disclosed an apparatus for applying a wall covering material to a wall surface. The apparatus comprises a body containing a reservoir for holding a portion of stucco material and a dispensing port extending therethrough, a handle extending from the reservoir and a vibrator for vibrating the reservoir.

The vibrator may comprise an eccentrically weighted shaft. The shaft may be rotated by a motor. The motor may be selected from the group consisting of electric pneumatic or hydraulic.

The body may be formed of sheet metal. The dispensing port may comprise a slot extending horizontally along the body. The slot may be substantially rectangular. The slot may have an adjustable height. The slot may be formed by an adjustable plate located along bottom edge of the slot. The adjustable plate may be selectably lockable to the body. The adjustable plate may be selectably secured to the body by fasteners. The hopper may include an open top. The hopper may have a substantially triangular cross section.

According to a further embodiment of the present invention there is disclosed a method for applying a wall covering material to a wall surface, the method comprising introducing a quantity of material into a reservoir, locating the reservoir proximate to the wall surface, providing a vibration to the reservoir and moving the reservoir in the direction along the wall surface to apply a portion of the material to the wall.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an apparatus for applying a material to a wall according to a first embodiment of the present invention.

FIG. 2 is a cross sectional view of the apparatus of FIG. 1 as taken along the line 2-2.

FIG. 3 is a side view of the apparatus of FIG. 1 proximate to a wall for applying stucco thereto.

FIG. 4 is a an exploded view of the front plate of the reservoir of the apparatus of FIG. 1.

FIG. 5 is a cross sectional view of the handle of the apparatus of FIG. 1 as taken along the line 5-5 in FIG. 2.

### DETAILED DESCRIPTION

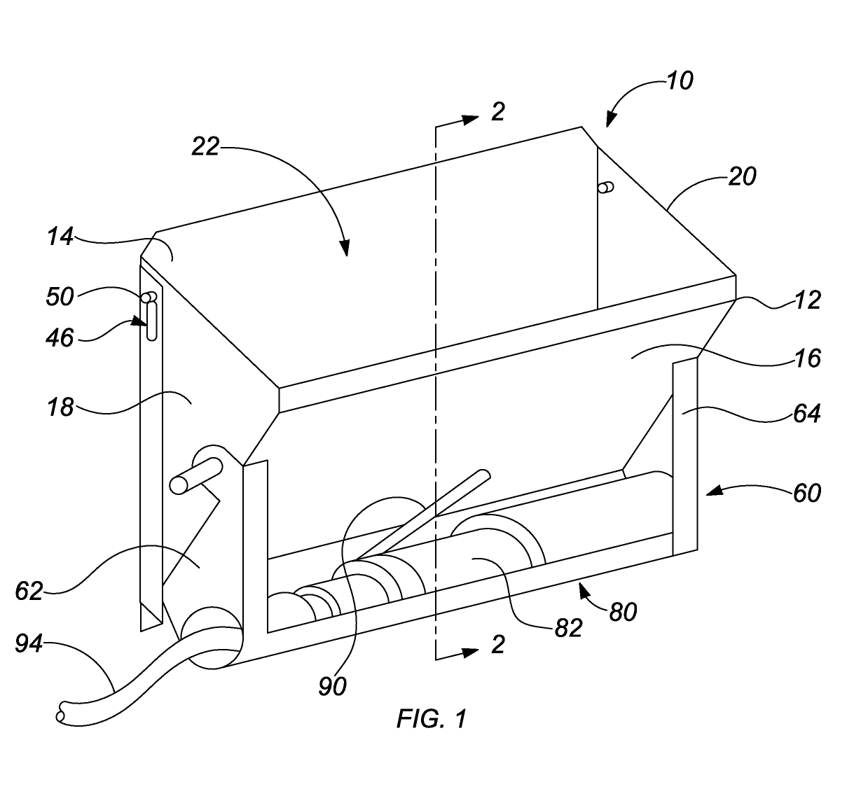

Referring to FIG. 1, an apparatus for applying a wall covering material to a wall surface according to a first embodiment of the invention is shown generally at 10. The apparatus 10 comprises a body 12 having a reservoir 22 therein and a handle 60 and a vibrator 80 connected thereto. The body 12 is formed of front and rear walls, 14 and 16, respectively and first and second side walls, 18 and 20, respectively. The front, rear and side walls, 14, 16, 18 and 20 define the reservoir 22 which may optionally include an open top as illustrated. The reservoir 22 is operable to receive a stucco material therein which may thereafter be dispensed through a port (not shown in FIG. 1) as will be more fully described below.

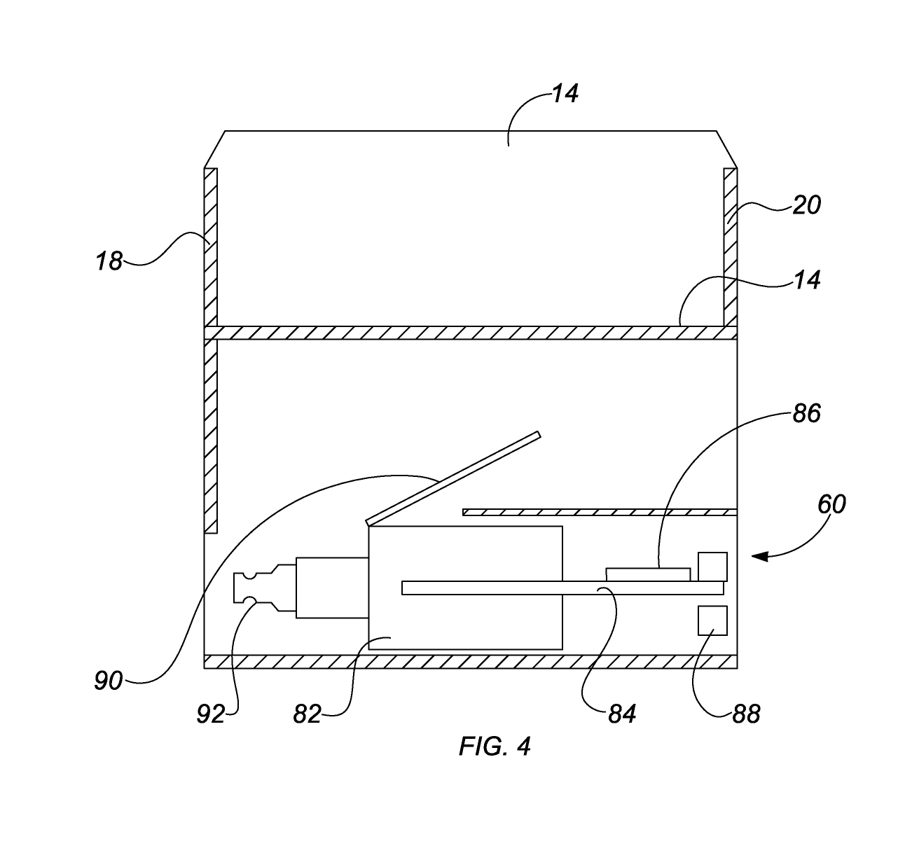

With reference to FIG. 4, the rear wall 16 and first and second side walls 18 and 20 are connected together to form a portion of the reservoir. The front wall 14 is selectably removable from the first and second side walls 18 and 20. As illustrated, the rear wall 16 includes a bottom extension 24 separated from a main portion 26 of the rear wall by slots 28. The slots 28 have a width sufficient to receive the front wall 14 therein. The rear wall 16 and first and second side walls 18 and 20 may be formed of any suitable material, such as, by way of non-limiting example, metal, plastic or composite materials. The rear wall 16 and first and second side walls 18 and 20 may be co-formed with each other or connected to each other by any suitable means, such as, by way of non-limiting example, adhesives, welding, fasteners or the like. Additionally, the apparatus may be formed by any known method, such as, by way of non-limiting example, moulding, casting or machining.

The front wall 14 comprises a substantially planar member extending between top and bottom edges, 30 and 32, respectively and first and second side edges 34 and 36, respectively. The bottom edge 32 includes a notched portion 38 having a top edge 40 therealong and first and second extensions 42 extending to either side of the notched portion 38. The notched portion 38 defines an opening or port through the reservoir for dispensing a portion of the stucco material therethrough as will be more fully described below. The front wall 14 also includes side taps 44 extending rearwardly from each of the first and second side edges 34 and 36. The side tabs 44 include adjusting apertures 46 therethrough for adjusting the location of the front wall 14 relative to the rear and side walls. As illustrated the adjusting apertures 46 may comprise slots, however it will be appreciated that other opening types may also be utilized as well, such as, by way of non-limiting example, a plurality of slots. The first and second side plates 18 and 20 include fastener bores 48 through which fasteners 50 or the like are passed to secure the adjusting apertures 46 thereto.

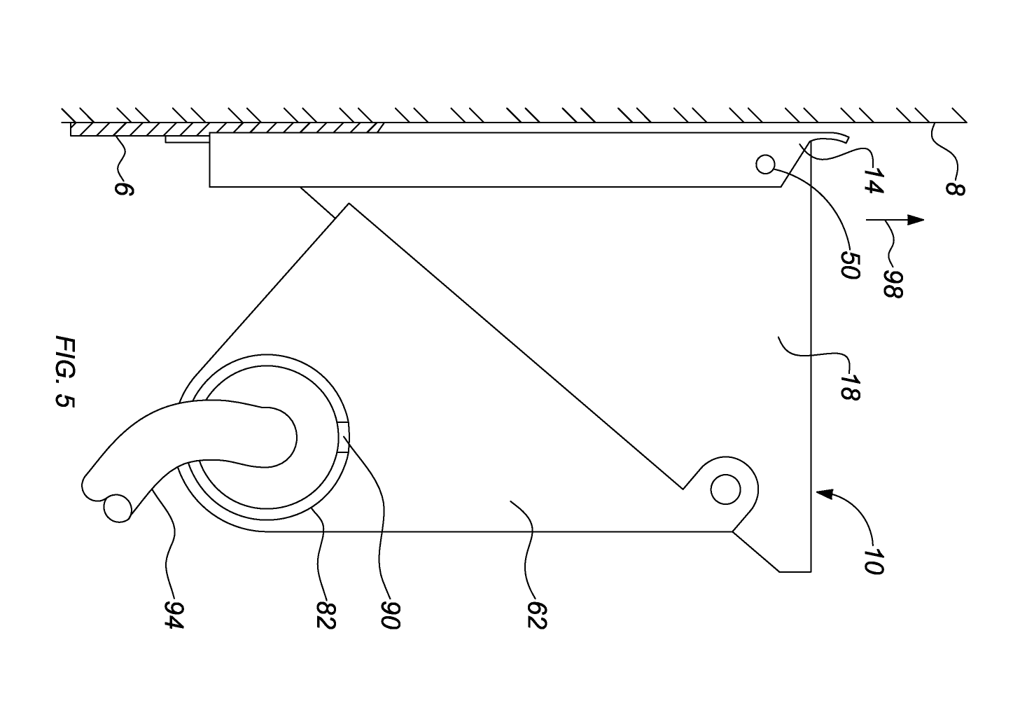

With reference to FIG. 1, the handle 60 comprises a substantially tubular member extending between first and second side brackets 62 and 64. The first and second side brackets 62 and 64 are secured to the first and second side walls 18 and 20. The handle may be substantially hollow to receive a vibrator 80. It will be appreciated that the handle 60 may also be formed of any other suitable shape, such as, by way of non-limiting example, square, triangular or irregular. The handle 60 includes a vibrator, generally indicated at 80 therein. As illustrated in FIG. 5, the vibrator 80 may be formed of a motor 82 having a shaft 84 extending therefrom. The shaft 84 may be eccentrically weighted, such as, by locating a weight 86 therealong, by way of non-limiting example. The shaft 84 may also include an end bearing or bushing support 88 as are commonly known in the art. The motor 82 comprise any known type, such as, by way of non-limiting example, electric, pneumatic or hydraulic and may include an actuating means, such as, by way of non-limiting example a lever 90 or button as are commonly known. As illustrated, by way of non-limiting example, for a pneumatic motor, the motor 82 may include a connector 92 for connection to a pneumatic supply line or the like. It will be appreciated that other connectors and supply means will be suitable for other motor types. The speed of the motor 82 may be adjusted or variable to adjust the speed of the material dispensed through the slot 96.

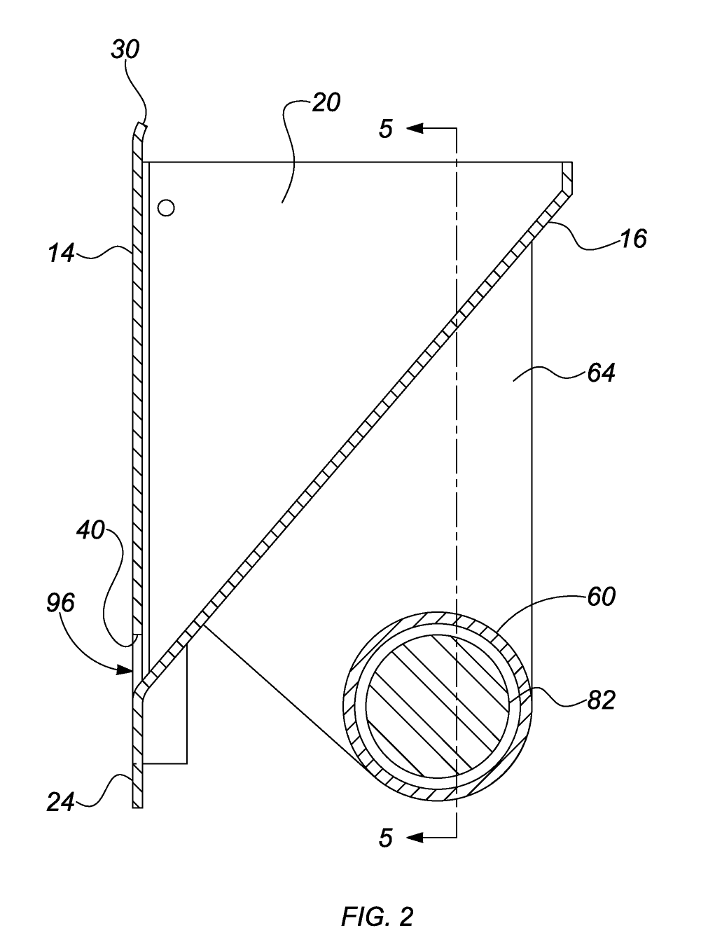

Turning now to FIG. 2, the front plate 14 may be secured to the rear plate 16 by passing the extensions 42 of the front plate 14 through the slots 28 of the rear plate and thereafter passing fasteners 50 through the adjusting apertures and fastener bores 46 and 48. In such a manner, the top edge 40 of the notch forms a slot, generally indicated at 96 with the bottom wall 16. The front wall 14 may be adjusted up and down relative to the rear wall 16 by moving the fasteners 50 within the adjusting apertures 46 so as to select a desired height of the slot 96. By way of non-limiting example, the height of the slot 96 may be selected to be between ¼ and 1½ inches (6 and 38 mm) high although it will be appreciated that other sizes may be useful as well depending upon the material to be dispensed therethrough. The height of the slot 96 may be adjusted by a user as set out above to adjust the quantity or rate at which a material is dispensed from the apparatus.

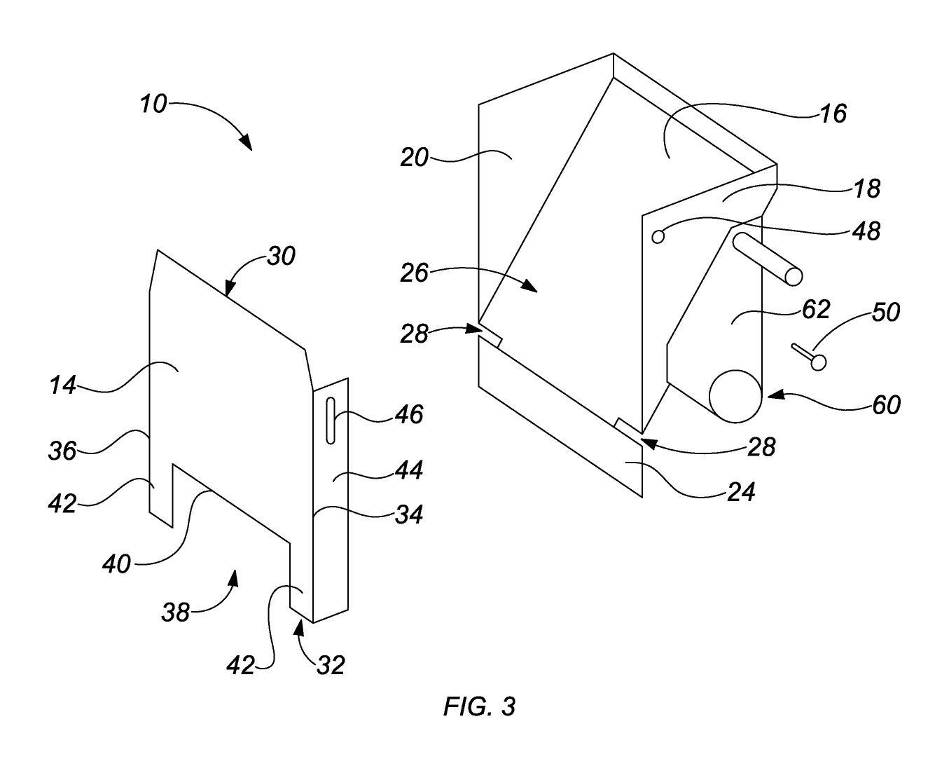

With reference to FIG. 3, in operation a user may introduce a quantity of the stucco material into the reservoir 22 and place the front wall 14 against a wall 8 to which the stucco is to be applied. Thereafter the user may activate the motor 82 to create a vibration in the apparatus and move the apparatus in an upward direction, generally indicated at 98 so as to dispense a quantity of stucco material 6 to the wall 8.

While specific embodiments of the invention have been described and illustrated, such embodiments should be considered illustrative of the invention only and not as limiting the invention as construed in accordance with the accompanying claims.

What is claimed is:

1. An apparatus for applying a wall covering material to a wall surface, the apparatus comprising:
a body containing a reservoir for holding a portion of stucco material and a dispensing port extending therethrough;
a handle extending from said reservoir; and
a vibrator for vibrating said reservoir.

2. The apparatus of claim 1 wherein said vibrator comprises an eccentrically weighted shaft.

3. The apparatus of claim 1 wherein said shaft is rotated by a motor.

4. The apparatus of claim 1 wherein said motor is selected from the group consisting of electric pneumatic or hydraulic.

5. The apparatus of claim 1 wherein said body is formed of sheet metal.

6. The apparatus of claim 1 wherein said dispensing port comprises a slot extending horizontally along said body.

7. The apparatus of claim 1 wherein said slot is substantially rectangular.

8. The apparatus of claim 1 wherein said slot has an adjustable height.

9. The apparatus of claim 1 wherein said slot is formed by an adjustable plate located along bottom edge of said slot.

10. The apparatus of claim 1 wherein said adjustable plate is selectably lockable to said body.

11. The apparatus of claim 1 wherein said adjustable plate is selectably secured to said body by fasteners.

12. The apparatus of claim 1 wherein said hopper includes an open top.

13. The apparatus of claim 1 wherein said hopper has a substantially triangular cross section.

14. A method for applying a wall covering material to a wall surface, the method comprising introducing a quantity of material into a reservoir, locating said reservoir proximate to said wall surface, providing a vibration to said reservoir and moving said reservoir in the direction along said wall surface to apply a portion of said material to said wall.
